(19) United States
(12) Patent Application Publication
(10) Pub. No.: US 2007/0252671 A1
(43) Pub. Date: Nov. 1, 2007

(54) Bimetallic Thermal Switch

(76) Inventors: Harald Bischoff, Neulingen (DE); Jens Radbruch, Neulingen (DE)

Correspondence Address: Orum & Roth, 53 W. Jackson Blvd, Suite 1616, Chicago, IL, 60604, US

(21) Appl. No.: 11/658,832

(22) PCT Filed: Jul. 22, 2005
(86) PCT No.: PCT/EP05/08001

§ 371 Date: Mar. 16, 2007

(30) Foreign Application Priority Data
Jul. 24, 2004 (DE) 10 2004 036 117.7

(51) Int. Cl. H01H 37/54

(52) U.S. Cl. 337/365

(57) ABSTRACT

The invention describes a bimetallic thermal switch comprising
an electrically insulating carrier (2),
a contact spring (4) made from a bimetallic material, which is carried by the electrically insulating carrier (2) and has two ends, one being fixed in position, and which is so formed, at least over a certain portion (4a), that it will abruptly change its curvature when its switching temperature is exceeded;
two electric supply lines (8, 9) held on the insulating carrier (2) and leading to two contact pieces (6, 7) disposed separately one from the other and from the contact spring (4);
and a contact bridge (5) mounted on the contact spring (4) opposite the two contact pieces (6, 7).

The present invention relates to a bimetallic thermal switch of the kind disclosed in DE 195 09 656 C2. The known bimetallic thermal switch comprises a housing that accommodates an insulating carrier in which is embedded a metallic carrier which latter carries a contact spring made from a bimetallic material. The contact spring is provided with a contact piece on its one end and has its opposite fixed end connected with a supply line outside the housing. A second supply line is brought out of the housing from a second contact piece provided opposite the first contact piece attached to the first contact spring.

A bimetallic thermal switch of that kind serves to protect electric devices, motors, transformers, or the like, from overheating. It should open when the temperature prevailing at its particular location exceeds a predefined limit value. The limit value will be described hereafter as the switching temperature. In order to give the bimetallic thermal switch a well-defined switching temperature, a certain portion of the contact spring, between its fixed end and its contact piece, is given a spherical shape by a stamping operation. This has the result that instead of varying its curvature continuously, the spherically shaped portion can only abruptly change its curvature when the temperature variation in the contact spring has built up a defined minimum mechanical stress, depending on the shape of the contact spring and its elastic properties. For safety reasons, predefined tolerances must be maintained for the switching temperature.

In the case of the known bimetallic thermal switch the current consumed by the electric device to be monitored flows through the contact spring. The current flow produces heat in the contact spring, depending on the current intensity and the ohmic resistance of the contact spring. This is a disadvantage in some applications as the Joule effect produced in the contact spring may give the false impression of a temperature higher than the temperature actually prevailing at the location of the electric device to be monitored. This may lead to undesirable action of the bimetallic thermal switch. That problem is aggravated by the fact that there is a tendency in electric engineering to develop ever higher power densities. Referring to bimetallic thermal switch this means that ever higher electric currents and peak flows must be led through ever smaller line cross-sections, including the cross-sections of bimetallic thermal contact springs. The problem is further aggravated by the fact that under safety aspects higher power densities also require a higher degree of reliability of the bimetallic thermal switches. At the same time, the engineer in charge with the development of bimetallic thermal switches is faced with the requirement that the solutions proposed by him should not be more expensive, but rather less expensive, than known solutions, if possible.

In order to achieve reliable switching in spite of the ever smaller line cross-sections and higher power densities, it has been known to provide an intermediate layer of a highly conductive metal, especially copper, between the two differently composed layers of the bimetallic thermal spring, which due to their different coefficients of thermal expansion bring about the switching action when a temperature change occurs and which in most of the cases have a relatively high electric resistance. This feature helps mitigate, but cannot eliminate, the influence of the Joule effect on the response of the bimetallic thermal switch. Unfortunately, that measure is expensive because the contact spring then no longer consists of a bimetallic material, but rather of a trimetallic material, and because the three-layered structure of the contact spring has detrimental effects on its mechanical properties.

Another problem results from the fact that due to the advancing miniaturization unavoidable production tolerances in the contact spring and irregularities in the shape of the contact springs, produced by stamping, occur between the bimetallic thermal switches of the same series, which lead to variations in the switching temperature that get even greater as the size of the bimetallic thermal switches is reduced. While this tendency can be counteracted by measuring the switching temperature of all bimetallic thermal switches in one series and sorting the bimetallic thermal switches so as to reduce the variations within a batch, this measure would be extraordinarily uneconomical.

There have also been known bimetallic thermal switches where the contact spring, instead of consisting of a thermostatic bimetal, is made from a highly conductive springy iron or copper alloy, and a separate bimetallic disk is provided for operating the contact spring, the disk being loosely arranged on the bottom or the upper surface of the contact spring so that the current to be switched by the bimetallic thermal switch will substantially not flow through the thermostatic bimetal. Such a bimetallic thermal switch has been known for example from EP 0 246 255 B1. Although in the case of such a bimetallic thermal switch the switching element (the bimetallic disk) is largely decoupled from the conducting element (the contact spring) of the bimetallic thermal switch, such a switch is more complex and expensive, with respect to production of its parts and its assembly, for example because the bimetallic disk must be produced separately and must be fitted and secured between hooks and links of the contact spring which likewise must be punched and bent separately.

Another bimetallic thermal switch, known from DE 198 27 113 A1, comprises a metallic housing of circular shape, viewed from the top, with an insulating cover and with two contact pieces fixed on the cover inside in diagonal arrangement. Arranged opposite the contact pieces is a contact plate which acts as a contact bridge and which can be operated together with a bimetallic disk and a spring washer located between the latter and the contact plate. The contact plate, the spring washer and the bimetallic disk are centrally riveted one to the other and are fixed in the housing by the spring washer which has its edge clamped between two housing parts. While the current lead and the bimetallic disk are largely decoupled one from the other in the case of these known bimetallic thermal switches, such switches are relatively expensive, as regards production of its parts and assembly, because of their particular structure and the larger number of functional parts needed.

Now, it is the object of the present invention to open up a way how a bimetallic thermal switch with a contact spring, made from a thermostatic bimetal and fixed on one of its ends, can be improved in such a way that it can be produced from a minimum of parts, in small sizes and at low cost and, at the same time, so that it will show reliable switching behavior largely uninfluenced by the Joule effect produced in the bimetallic thermal switch.

That object is achieved by a bimetallic thermal switch having the features defined in claim 1. Advantageous further developments of the invention are defined in the sub-claims.

The bimetallic thermal switch according to the invention comprises an electrically insulating carrier, a contact spring made from a bimetallic material which is carried by the carrier and is so formed, at least over a certain portion, that it will abruptly change its curvature when its switching temperature is exceeded, two electric supply lines held on the insulating carrier that lead to two contact pieces disposed separately one from the other and from the contact spring, and a contact bridge mounted on the contact spring opposite the two contact pieces.

This arrangement provides the following advantages:
The bimetallic thermal switch consists of a minimum number of parts, namely of two supply lines that lead to two contact pieces, one contact spring made from a thermostatic bimetal and one electrically insulating carrier that carries the three elements. It seems to be impossible to manage with a lesser number of parts.
The small number of parts encourages efficient and automated production solutions.
The electrically insulating carrier can be formed at low cost from a plastic material by injection molding.
The supply lines and the contact spring may be embedded in the insulating carrier, especially by embedding them in the plastic material. On the other hand, however, it is also possible to form the insulating carrier in two parts, connected one with the other, with the supply lines and the contact springs positively fixed, for example snapped into place, between those two parts. The two parts of the insulating carrier may be identical one to the other so that they can be joined symmetrically.
The supply lines, with their contact pieces, and the bimetallic contact spring may by formed from a pre-punched strip-like semi-finished product. This provides advantages with respect to automated production. The contact pieces and the contact bridge may be pre-fixed on the strip-like semi-finished product by riveting, soldering or welding. This can be effected for example by continuously attaching a contact profile for the contact bridge to the bimetal strip by roll seam welding. Such a semi-finished product can then be used to form separate contact springs by stamping and punching. Correspondingly, the supply lines to the contact pieces can likewise be formed from a strip-like semi-finished product. On the other hand, however, it is also possible to produce the supply lines by welding, soldering or riveting separate contact pieces onto the semi-finished product. Contact layers suited for switching lower currents may be formed by galvanic coating.
Although the bimetallic thermal switch according to the invention comprises a thermostatic-bimetal contact spring for direct switching of the currents to be switched, the current flowing through the switch practically does not influence the switching behavior because the current substantially takes the shortest way from one contact piece via the contact bridge to the other contact piece and because, regardless of the material from which the thermostatic-bimetal contact spring is made, the contact bridge may consist of a highly conductive material, especially one based on copper or silver, and may have a sufficiently large line cross-section without any disadvantageous consequences for the switching behavior of the bimetallic contact spring, even in the case of miniaturized switches.
Contrary to the case of a centrally held bimetallic disk, a bimetallic thermal switch according to the invention may use a contact spring that is fixed on one of its ends and which opens or closes the switch at its opposite end. In the open position of the switch, one thereby achieves a greater contact spacing than would be realizable with a centrally attached bimetallic disk of equal length. This is of particular importance for miniaturized switches where short contact springs are desired.

The contact spring of the bimetallic thermal switch according to the invention can be formed in any known way, for example can be given a bulging shape by stamping, in order to ensure that it will change its curvature only when its switching temperature is exceeded. That deformation conveniently occurs only in the central area of the contact spring. The contact bridge preferably is mounted on the contact spring outside of that portion which due to its particular shape changes its curvature abruptly, most conveniently directly on the movable end of the contact spring.

Especially well suited as a contact bridge is a profiled section made from a highly conductive contact material, especially one based on copper or silver. The contact bridge is attached to the contact spring conveniently by riveting, welding or soldering, preferably already during production of the strip-like semi-finished product from which the contact springs, provided with the contact springs, are formed by stamping, punching and, if necessary, by bending. However, the contact bridge need not necessarily be rigidly fixed on the contact spring. Instead, it may be attached to the contact spring in the way of a rocker, by connecting it with the contact spring centrally and with a certain play, for example using a clamp or a rivet. Such an embodiment provides the advantage that any maladjustment of the contact bridge and/or of the contact pieces can be balanced out to ensure that the contact bridge will come to lie against both contact pieces with equal accuracy.

The contact spring may be fixed on the insulating carrier directly by its fixed end. Such an embodiment is especially well suited for open-air switches where the contact mechanism is not protected by a housing. In the case of bimetallic thermal switches that have their contact mechanism enclosed by a housing it is preferred to fasten the contact spring on the insulating carrier not directly, but rather indirectly, especially by connecting that end of the contact spring which is remote from the contact bridge with a metallic carrier by welding, soldering, clamping, crimping or riveting, while the metallic carrier itself is held on the insulating carrier. The metallic carrier should distinguish itself by a rigidity greater than that of the contact spring in order to ensure that the switching behavior and the switching travel will not be influenced by accidental bending of the metallic carrier. The metallic carrier as such is conveniently embedded in part, and thereby firmly anchored, in the insulating carrier.

Preferably, the metallic carrier is firmly connected with the insulating carrier in two points spaced one from the other. This gives the metallic carrier improved bending stiffness and torsional rigidity. This effect may even be improved by giving the metallic carrier the shape of a U, viewed from the top, and by fixing, especially embedding, the two legs of the U on or in the insulating carrier. An especially advantageous solution is obtained when the surface of the legs of the U is bent off relative to the base of the U and the fixed end of the contact spring is attached to the base of the U connecting the legs.

Preferably, the legs of the U extend along the lateral walls of a flat housing for improving the latter's dimensional stability when pressure is applied from the outside, an advantage that may be of importance in some applications of bimetallic thermal switches.

The use of a metallic carrier for the bimetallic contact spring provides the additional advantage that the fixed end of the contact spring can be located at the end of the housing remote from the insulating carrier, while the free end of the contact spring, carrying the contact bridge, can be located near the insulating carrier. This makes it easier to locate the two contact pieces, with which the contact bridge is to cooperate, at well-defined points which require only extremely short supply lines that need to project beyond the insulating carrier only by a short length. Such a design leads to very sturdy arrangements even in the case of miniaturized switches. In addition, short supply lines make any faulty positioning of the contact pieces rather improbable, which is an advantage in terms of production automation.

The housing of the bimetallic thermal switch may be made from metal or from a plastic material. A metallic housing is preferred. With respect to the metallic carrier of the contact spring it is preferred to have it insulated in relation to the housing. However, the invention also allows an embodiment where the metallic carrier of the contact spring is in contact with the metallic housing or is electrically connected to it in some other way. This arrangement provides the advantage that the bimetallic temperature switch can be used also in an Y-connection where electric contact is made not only to the supply lines leading to the fixed contact pieces of the switch, but also to the housing.

Conveniently, the supply lines to the contact pieces are embedded in the insulating carrier, as are the legs of the metallic carrier. Preferably, the switch has a mirror-symmetrical design relative to the two contact pieces or the electric supply lines carrying them.

When the switch is provided with a housing, the electrically insulating carrier conveniently also may serve as a means for closing the housing, being fitted and fixed in the latter from one of its ends. Fixing of the carrier can be effected for example by bonding, clamping, by beading the edge of the housing relative to the insulating carrier, or by ultrasonic welding. As a supplementary measure, the housing may be sealed by closing any opening in the housing that still remains after fitting of the electrically insulating carrier, using a curable sealing compound. In cases where sealing is not absolutely necessary, the switch may be protected in the conventional way by shrinking on a section of a shrink-down plastic tubing which simultaneously serves as protection from contact with current-carrying connections.

Certain embodiments of the invention are illustrated in the attached drawings. Identical or corresponding parts are designated by the same reference numerals in the different examples.

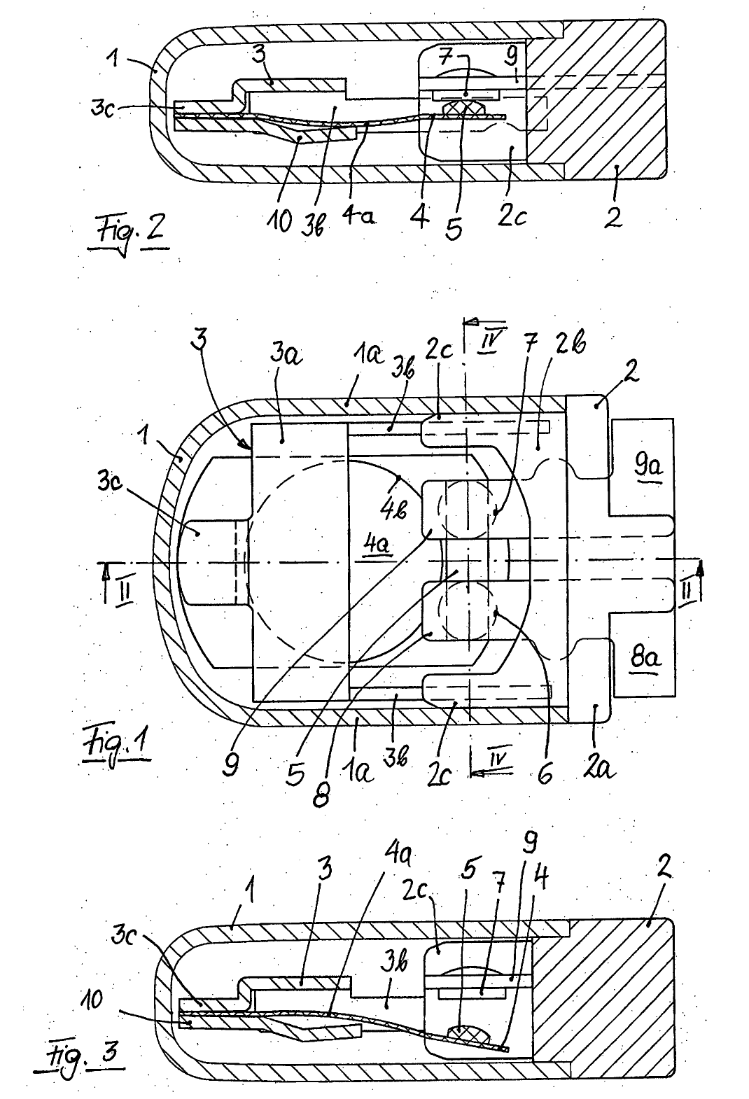

FIG. 1 shows a top view of the contact mechanism of a switch according to the invention, with the housing cut open;

FIG. 2 shows a lengthwise section through the switch illustrated in FIG. 1, taken along line II-II, with the contacts closed;

FIG. 3 shows an illustration similar to FIG. 2, with the contacts in open condition;

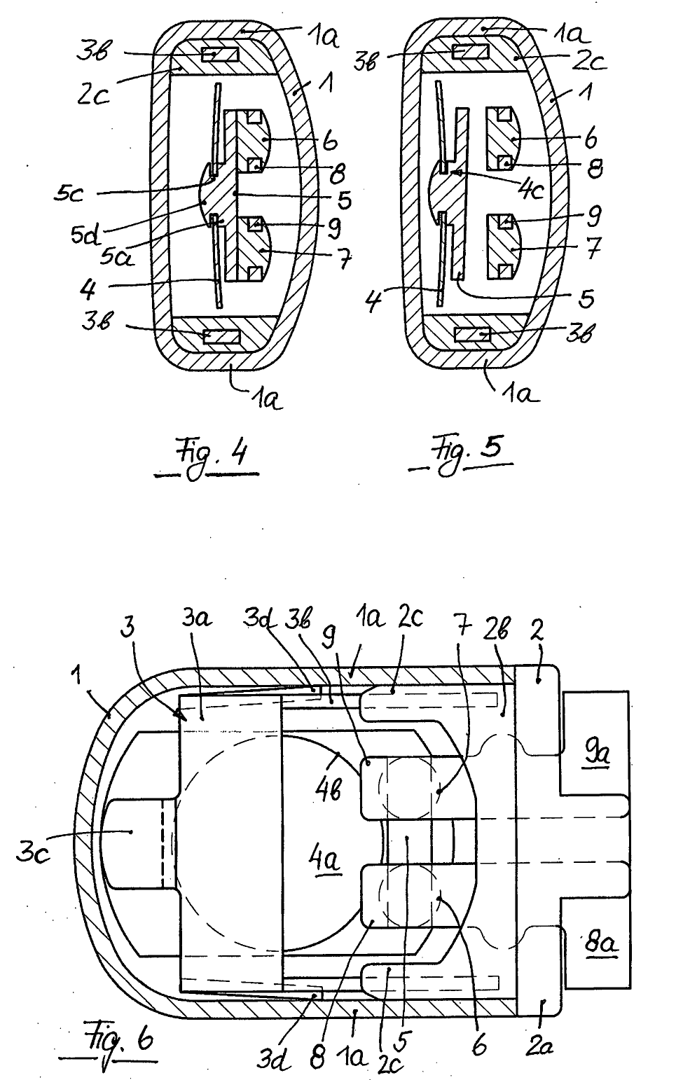

FIG. 4 shows a cross-section through a modification of the switch illustrated in FIG. 1, taken along line IV-IV in FIG. 1, with the switch in closed condition;

FIG. 5 shows a cross-section similar to FIG. 4, but with the switch in open condition; and

FIG. 6 shows an illustration similar to FIG. 1 of a third example of the switch according to the invention.

FIGS. 1 to 3 show the bimetallic thermal switch in greatly enlarged scale (approximately 10:1). It comprises a flat housing 1, made from metal or a plastic material, with an opening on one end that is closed by an insulating carrier 2. The insulating carrier 2 is a molded plastic part having a flange 2a outside the housing 1 and an inner element 2b that positively engages the housing 1. The flange 2a abuts against the edge of the opening of the housing 1. The inner element 2b is provided with lateral extensions 2c that lie against the side walls 1a of the housing 1.

Arranged in the housing 1 is a metallic carrier 3 of substantially U-shaped form, viewed from the top. Accordingly, the carrier comprises a base 3a and two legs 3b projecting from that base 3a. Further, a stud-like extension 3c projects centrally from the base 3a in a direction opposite to the direction of the legs 3b. Soldered or welded to the extension 3c are a contact spring 4 made from a bimetallic material, that extends in parallel to the legs 3b and in the same direction, as well as a trimming bracket 10, which may also be dispensed with. Instead of fixing the contact spring 4 by soldering or welding, it may also be fixed by riveting, clamping or crimping. The metallic carrier 3 may be formed from sheet metal by punching or bending. Its legs 3b are bent off from the base 3a at a right angle, extend in parallel to the side walls 1a of the housing 1 and into the insulating carrier 2, in the area of the extensions 2c, where they are embedded and anchored in the extensions 2c preferably by undercuts formed in the embedded sections of the legs 3b. The insulating carrier 2 and the metallic carrier 3 thus form a sturdy assembly which is especially well suited as a base for building up the contact mechanism of the bimetallic thermal switch.

The movable end of the contact spring 4 is provided with a contact bridge 5, which extends transversely to the longitudinal direction of the legs 3b and the contact spring 4 and which is fixed on the contact spring by riveting, soldering or welding. In the central area of the contact spring 4, between the stud-like extension 3c and the movable end on which the contact bridge 5 is located, the contact spring 4 is provided with a spherical stamped portion 4a of approximately circular contour 4b. By giving the contact spring that shape it is ensured that the bimetallic thermal switch will open or close abruptly when its switching temperature is exceeded. Instead of providing the illustrated spherical stamped portion 4a, the contact spring 4 may also be given a differently shaped bulging form so long as it will lead to an abrupt change in curvature of the contact spring 4 when the switching temperature is exceeded; for example, the shape of the bulging portion may also be trapezoidal, viewed transversely to the surface of the contact spring.

Two contact pieces 6 and 7 are arranged opposite the contact bridge 5. The insulating carrier 2 carries the two contact pieces 6 and 7 one separately from the other, for which purpose two metallic supply lines 8 and 9, made from sheet metal, are embedded in the carrier 2 so that the two ends of each of the lines project from the carrier 2. The two contact pieces 6 and 7 are arranged on those sections of the supply lines 8 and 9 that project into the housing 1. On the opposite side of the insulating carrier 2, each of the two supply lines 8 and 9 forms a terminal lug 8a, 9a, on which flexible connection lines, for example, can be fixed later.

The illustrated switch can be produced in miniaturized form. It comprises a minimum number of parts, which is an advantage with respect to automated assembly. Even in the case of such a miniaturized design, the current flowing through the switch will practically not influence the switching behavior.

FIGS. 4 and 5 show a modified embodiment of the switch illustrated in FIGS. 1 to 3. That switch is modified insofar as the contact bridge 5, instead of being rigidly connected with the contact spring 4, is designed in the form of a rocker. The contact bridge 5, being rectangular in shape when viewed from the top, is provided for this purpose, on its side facing the contact spring 4, with a central projection 5a with a mushroom-shaped extension 5b which latter consists of a neck portion 5c and head portion 5d. The neck 5c is caught in a matching hole 4c with a certain play. The hole 4c and the neck 5c have a contour differing from a circular shape; preferably, their contour is rectangular so that the contact bridge 5 is prevented from rotating on the contact spring 4. The contact bridge 5 may be mounted on the contact spring 4, for example by initially forming the neck 5c on the projection 5b, then fitting it in the hole 4c punched out in the contact spring 4, and finally forming the head 5d using a shaping tool that comprises a die with a contour that defines the shape of the head 5d, in the way of a riveting operation.

This embodiment provides the advantage that any misalignment between the contact bridge 5 and the two contact pieces 6 and 7 of the kind illustrated in FIG. 5 can be balanced out automatically due to the potential rocking motion so that the contact bridge 5 will in any case come into full-surface contact with the two contact pieces 6 and 7, as illustrated in FIG. 4.

The embodiment illustrated in FIG. 6 differs from the embodiment illustrated in FIGS. 1 to 3 in that a tongue 3d is cut out from each of the legs 3b of the metallic carrier 3. The two tongues 3d are bent off to the outside and rest against the side walls 1a of the housing 1, being in this case made from metal, at some mechanical pre-stress so that the metallic carrier 3 and the housing 1 will always see the same electric potential. This allows the bimetallic thermal switch to be used in a Y-connection where electric contact is made not only at the two terminal lugs 8a and 9a, but also at the housing 1.

1. A bimetallic thermal switch comprising
an electrically insulating carrier;
a contact spring made from a bimetallic material, which is carried by the electrically insulating carrier and has two ends, one being fixed in position, and which is so formed, at least over a certain portion, that it will abruptly change its curvature when its switching temperature is exceeded;
two electric supply lines held on the insulating carrier that lead to two contact pieces disposed separately one from the other and from the contact spring;
and a contact bridge mounted on the contact spring opposite the two contact pieces.

2. The bimetallic thermal switch as defined in claim 1, wherein the contact bridge is mounted on the contact spring outside of that portion which due to its particular shape changes its curvature abruptly.

3. The bimetallic thermal switch as defined in claim 1 wherein the contact bridge is a section cut from a profiled material.

4. The bimetallic thermal switch as defined in claim 1, wherein the contact bridge is fixed on the contact spring by welding, clamping, crimping, riveting or soldering, welding and riveting being preferred for that purpose.

5. The bimetallic thermal switch as defined in claim 1, wherein the contact spring is fixed on the insulating carrier directly with its end remote from the contact bridge.

6. The bimetallic thermal switch as defined in claim 1, wherein the contact spring is fixed indirectly on the electrically insulating carrier.

7. The bimetallic thermal switch as defined in claim 6, wherein the contact spring is fixed on a metallic carrier with its end remote from the contact bridge, the metallic carrier being itself carried by the insulating carrier.

8. The bimetallic thermal switch as defined in claim 7, wherein a portion of the metallic carrier is embedded in the insulating carrier.

9. The bimetallic thermal switch as defined in claim 8, wherein a positive fit exists between the metallic carrier and the insulating carrier.

10. The bimetallic thermal switch as defined in claim 7, wherein the metallic carrier is rigidly connected with the insulating carrier at two points that are spaced one from the other.

11. The bimetallic thermal switch as defined in claim 1, wherein the supply lines are embedded in the insulating carrier.

12. The bimetallic thermal switch as defined in claim 1, wherein the switch comprises a housing that accommodates a switching mechanism comprising the contact spring with the contact bridge, the contact pieces located opposite the latter and the insulating carrier.

13. The bimetallic thermal switch as defined in claim 12, wherein the housing is made from metal.

14. The bimetallic thermal switch as defined in claim 7 wherein the metallic carrier is electrically insulated from the metallic housing.

15. The bimetallic thermal switch as defined in claim 7 wherein the metallic carrier is connected with the metallic housing in an electrically conductive way.

16. The bimetallic thermal switch as defined in claim 15, wherein the metallic carrier is in contact with the housing.

17. The bimetallic thermal switch as defined in claim 12, wherein the housing is made electrically insulating.

18. The bimetallic thermal switch as defined in claim 1, wherein it has a mirror-symmetrical design as far as the position of the two contact pieces is concerned.

19. The bimetallic thermal switch as defined in claim 1, wherein it has a mirror-symmetrical design as far as the position of its two supply lines is concerned.

20. The bimetallic thermal switch as defined in claim 7, wherein the metallic carrier has the shape of a U, when viewed from the top, and has its two legs of the U embedded in the insulating carrier.

21. The bimetallic thermal switch as defined in claim 20, wherein the contact spring is attached to the base of the U that connects the legs.

22. The bimetallic thermal switch as defined in claim 20 wherein the legs have a surface that is bent off relative to the base of the U.

23. The bimetallic thermal switch as defined in claim 1, wherein the contact bridge consists of a material of higher electric conductivity than the bimetal of the contact spring.

24. The bimetallic thermal switch as defined in in claim 20, wherein the supply lines are embedded in the insulating carrier and the legs of the U are located close to the oppositely arranged side walls of the housing.

25. The bimetallic thermal switch as defined in claim 1, wherein the contact bridge is mounted on the contact spring in the way of a rocker.
